(19) United States
(12) Patent Application Publication
(10) Pub. No.: US 2023/0394529 A1
(43) Pub. Date: Dec. 7, 2023

(54) Apparatus and Method for Implementing a Communication from a Premises Display Apparatus to a Personal Display Apparatus

(71) Applicant: David Hazzard, Longwood, FL (US)

(72) Inventor: David Hazzard, Longwood, FL (US)

(21) Appl. No.: 18/208,482

(22) Filed: Jun. 12, 2023

Related U.S. Application Data
(63) Continuation of application No. 17/955,508, filed on Sep. 28, 2022, now abandoned.
Application No. 17/955,508 is a continuation of application No. 16/884,982, filed on May 27, 2020, now abandoned.

(51) Int. Cl. G06Q 30/0251; G06F 3/04817; G06Q 30/02; H04M 1/72436; H04M 1/72445; H04N 21/414

(52) U.S. Cl. CPC G06Q 30/0267; G06F 3/04817; G06Q 30/0281; H04M 1/72436; H04M 1/72445; H04N 21/41415; G06Q 30/0257

(57) ABSTRACT

An apparatus and a method for displaying content of a third party to a cellular phone of a patron of premises are shown and described. The premises may be for example a restaurant in which a premises display apparatus which is part of the apparatus system is placed on a table used by the patron. The patron may utilize the premises display apparatus to cause a particular commercial solicitation by the third party to appear on a screen of his or her cellular phone by an initiating action by the patron. The communication may be a commercial transaction completed using the cellular phone. The premises display apparatus selectively enables a generic menu of third party icons, or a home web page of one or more third parties, or another specific web page of any selected third party or via an application to be displayed on the cellular phone.

### CROSS-REFERENCE TO RELATED APPLICATIONS

This application is a Continuation Application of and claims the benefit of priority to U.S. patent application Ser. No. 17/955,508 filed on Sep. 28, 2022, and U.S. patent application Ser. No. 16/884,982 filed on May 27, 2020, the contents of both are incorporated by this reference.

### FIELD OF THE INVENTION

The present invention relates to electrical communications, and more particularly, to methods and apparatus for making content easily available on a personal communications device such as a mobile/cellular phone.

### BACKGROUND OF THE INVENTION

A patron at commercial premises such as bars and restaurants may wish to engage in additional activities beyond the scope ordinary accommodated in those premises, while remaining at the premises for the original purposes of those premises. These activities may be under the auspices of commercial entities or organizations not directly affiliated with the commercial premises occupied by the patron. Ordinarily, the patron may have to exit the premises, and communicate with the commercial entities associated with the additional premises. This communication may be via cellular phone or via internet connection, for example.

This may be objectionable to the patron for any one of several reasons. For example, in crowded premises, to leave may result in surrendering seating or other accommodations. Also, time required to leave, establish communication with the party associated with the additional premises, and to return may require more time than is desirable. In addition, patrons of such establishments provide for what is essentially a captive audience that the establishment owner/operator can provide advertising content from third party commercial entities for the patron to potentially interact with while at the various establishments.

There exists a need to accommodate patrons who wish to temporarily engage other commercial entities, yet remaining at the original premises.

### SUMMARY OF THE INVENTION

The present invention contemplates an apparatus system and a method for implementing a communication between a public display apparatus at a premises to a personal display apparatus by a patron of the premises. The premises may be commercial, for example, and may not be associated by purpose to a third party participating in the wireless transaction. Illustratively, a restaurant may place a table top display apparatus which is part of the apparatus system on a table used by the patron.

The patron may utilize the display apparatus to cause a particular commercial solicitation/advertisement by a third party to appear on the screen of his or her cellular phone. The transaction is performed on the cellular phone.

More particularly, the display apparatus selectively enables a web-based generic menu of third party icons, or a home web page of one or more third parties, or another specific web page of any selected third party to be displayed on the cellular phone. The final effect is to enable the patron to navigate quickly to the exact site or web page of interest, without having to engage in tedious intermediate steps ordinarily required when navigating on a personal computer or the like.

In this scenario, the restaurant is not associated with the third party providing the product. For example, the product which is the subject of the transaction may be a service such as a movie, and the transaction may involve the patron purchasing tickets to the movie.

The display apparatus can sit passively on the table and offer the patron a way to complement the meal, for example. The patron may derive a benefit from having choices of activities, services, or goods made available over the internet using his or her private cellular phone. This is accomplished with minimal disruption to the patron, who can order goods or services without leaving his or her table at the restaurant.

Thus, in the example above, the restaurant serves as an advertising venue for the benefit of a movie theater. A commercial arrangement between the restaurant and the movie theater may result in compensation to the restaurant. Obviously, both the movie theater and the restaurant benefit from this arrangement.

In a further example, the same may apply to a bar, where the table of the restaurant example may possibly be replaced by the bar itself, or a combined restaurant and bar.

The invention may be thought of as an apparatus of the system, and also as a method for implementing communication between a display device and a personal communication device.

In one scenario utilizing the novel system and method, a patron and family go to a restaurant. A display sitting on their table cycles through a succession of advertisements for diverse third party vendors. One particular advertisement displays movies that are currently playing at a local theater. Using the novel system, the patron need only interact with the display apparatus in some way contemplated here and responsively, the cellular phone displays a screen including a number of icons of third party advertisers, one of which is that of the local theater. The patron can then click on the icon, and thereby open a home page of the theater's website, and purchase tickets online.

This first scenario of the purchasing of theater ticket is broadly represented by FIG. 3, wherein the communication between the premises display apparatus and the personal communications device brings up a generic page of icons on the patron's phone where each icon represents a third party vendor. And when the patron invokes or activates the vendor specific icon its phone, a web page associated with the vendor ad is displayed on the patron's phone.

In a second scenario utilizing the novel system and method, a patron is sitting at a table at the restaurant, and viewing cycling advertisements. One advertisement features a ticket provider advertising that tickets are still available for an upcoming professional football game next Sunday. The patron can tap his cellular phone on the display apparatus, which once again summons the icons of third party advertisers, which of course may include that of the ticket provider. The patron clicks on the ticket vendor icon. Responsively, the ticket vendor's specific webpage appears on the patron's cellular phone for purchasing tickets to the advertised game. The patron can then use his or her phone to complete the ticket purchase to the game originally advertised on the table top display at the restaurant.

This second scenario of the purchasing of a sporting event ticket is represented by FIG. 2, wherein the communication between the premises display and the personal communications device brings up a generic page of icons on the patron's phone where each icon represents a third party vendor. And when the patron activates the vendor specific icon its phone, a specific page (e.g. a page showing the actual game seating arrangement for the advertised game and seats available) is displayed on the patron's phone, thereby expediting and simplifying the patron's ability to purchase tickets.

In a third exemplary scenario, the patron may be at a local sports bar watching a live televised horseracing event. At the bar, a the table top display apparatus cycles through advertisements and in so doing, displays an advertisement of a betting service offering betting on races at the watched track. The advertisement may for example indicate that the next race will post in the next five minutes, and that bets may be placed accordingly. The screen of the display apparatus flashes a message reading “Tap now to place a bet”. The patron can use his or her cellular phone to tap on the display apparatus. Responsively, the patron's web browser opens to a page specific to the particular race, thereby enabling the patron to place a bet in an expedited manner prior to posting the race. In an option, the interaction activated by tapping could bring a more generic page, such as a log in page at the betting service or the home page of the betting service to the screen of the patron's cellular phone. Again, the patron completes the desired bet on his cellular phone.

This third scenario of the placing a sports bet is represented by FIG. 4, wherein the communication between the premises display and the personal communications device bypasses the generic page of icons as in scenarios one and two above, and instead activates a vendor specific page (e.g. directly opening the vendor's page that facilitates the patron to place a bet) is displayed on the patron's phone, thereby further expediting and simplifying the patron's ability to place the bet in a timely manner.

In each of these scenarios, the patron can instantly engage the third party vendor, without the cumbersome steps such as obtaining and entering a URL during the process.

Beyond being a mere communications instrument, the apparatus and method may become attractions on their own merits, as both being able to summon convenient communications avenues for temporary activities, and also to integrate with operations of the original premises.

Most notably, the invention enables premises such as restaurants and bars to enable ready communication with one and preferably several third party vendors, using quick, convenient connection through a table top display apparatus to a patron's mobile device. The display apparatus is able to communicate to the patron's mobile device using various technologies including near field communication (NFC). Navigation to the third party vendor's internet presence, and to specific pages in the internet presence on the patron's mobile device is quick and easy using the protocols in place for interactive use with the table top display apparatus.

Note the mechanism of interaction/communication between the table top display apparatus and the patron's mobile phone is preferably (NFC) where the patron can simply bring its mobile phone in close contact with the display apparatus and the information from the display apparatus results in the opening of the web browser on the patron's mobile phone to the communicated web page. Alternatively, the display apparatus could provide a number for the patron to send a text to which would result in a return text with a link on the patron's mobile phone to the communicated web page. Further, an additional mode of communication could be a two dimensional barcode on the display apparatus, such that when the patron utilizes its phone to scan the two dimensional barcode, the information from scan on the display apparatus results in the opening of the web browser on the patron's mobile phone to the communicated web page. Other modes of communication known in the art are also contemplated by the inventor. For example, the communication from the display apparatus to the mobile may open an app on the patron's mobile phone that is either generic in that it offers access to the icons related to the third party vendors advertising on the table top display apparatus or specific in that it opens up the app related to a specific vendor advertising on the table top display apparatus.

As will be further detailed herein, communications can be quickly established by enabling the patron to interact with the table top display apparatus with the patron's mobile phone. This quick and simple interaction between the two devices may bring up on the patron's mobile device a generic web-based page that includes at least one, but likely many, invokable icons of third party vendors that are likely presented (or not) in advertisements displayed on the table top device. Such that if the patron sees an advertisement on the table top display apparatus of a particular third party vendor that it is interested in, the patron can communicate with the table top display apparatus in such a way that it will cause the patron's mobile device to open a generic web-based page that will include the invokable icons of third party vendors, including the icon of the vendor that the patron was interested in from the advertisements. The patron can then select the invokable icon from its phone, which may be a URL link that will direct the patron's browser to the third party vendor's home page, to a specific page within the third party vendor's website, or a specifically designated page that may be independent of the third party vendor's website. In a further option, the patron may engage a particular advertisement that may appear on the display apparatus on the table. This may be used to bypass a generic initial screen on the display apparatus, and expeditiously bring the patron to his or her desired destination.

It should be stressed that steps of the novel method enable the patron to engage the third party vendors in a manner that is familiar and intuitive, using the patron's cellular/mobile phone. The ease and speed with which the desired transactions can be completed will be appreciated by the patron and may possibly become an attraction benefiting the restaurant, bar, or other premises.

The present invention provides improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic view of elements of a system for implementing a wireless transaction by a patron of e.g., commercial premises;

FIG. 2 shows progressive views of screen displays as the screen of one of the elements of FIG. 1 changes;

FIG. 3 is similar to FIG. 2, but shows different screen displays;

FIG. 4 is a side view of the system of FIG. 1, but shows different screen content in two renditions of a cellular phone of the system;

FIG. 5 is a block diagram graphically presenting steps of one implementation of the novel method;

FIG. 6 is a block diagram graphically representing a more efficient implementation of the novel method;

FIG. 7 is a block diagram graphically illustrating two forms of control of content in the novel method; and

FIG. 8 is a block diagram showing steps which may be practiced in many variations of the novel method, in which bocks of optional steps are not necessarily connected to blocks of other steps.

### DETAILED DESCRIPTION

A novel system for implementing a communication between a public display apparatus at a premises to a personal display apparatus by a patron of the premises be now described, first more generically or abstractly, and subsequently with reference to anticipated practical applications, such as in a restaurant, a bar, or a combination of these.

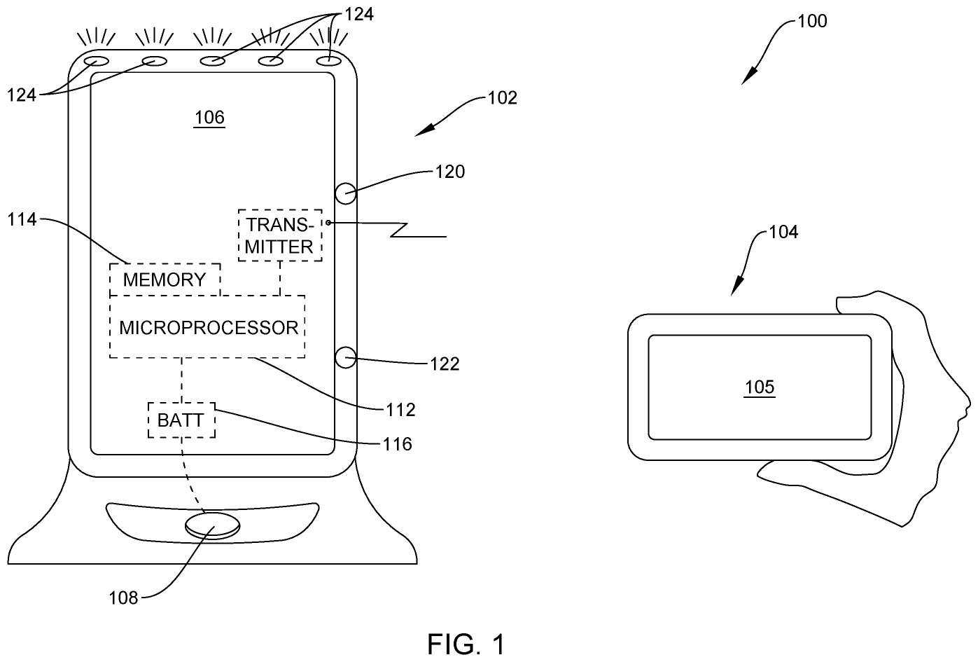

Referring first to FIG. 1, according to at least one aspect of the invention, there is shown premises display apparatus 102 for implementing a communication by a patron of premises that could lead to a transaction by the patron. The premises may possibly not be party to the transaction. Premises display apparatus 102 may use a premises/table top display 106 maintained at the premises and a personal communications device 104 such as a mobile/cellular phone operated by the patron. Personal communications device 104 may be mobile, cellular or a smartphone, for example. The terms “mobile personal communications device”, “personal communications device”, “personal display apparatus”, “personal display device”, “cellular phone”, “smart phone”, and “mobile phone” will be used interchangeably herein.

Premises display apparatus 102 is for displaying content of a third party vendor and communicating the content of the third party vendor to a patron's personal communications device 104 operated at the premises. Premises display apparatus 102 may comprise a display screen 106 for displaying the third party vendor content, a data processor 112 including a memory 114 containing data corresponding to the third party vendor content, and computer instructions configured to display the third party content on premises display apparatus 102. Premises display apparatus 102 may also comprise an access element to enable the patron's personal communications device 104 to access the third party content, and a transmission element to enable the communication of the third party content to the patron's personal communications device 104. Content of the third party vendor may comprise advertising, for example. The access element may comprise apparatus, possibly working in conjunction with the computer instructions, configured to receive an input from the patron and responsively, to initiate control of display screen 106. The transmission element may comprise for example, a wireless transmitter or transceiver 110.

Computer instructions loaded into microprocessor 112 (FIG. 1) are configured to effect communication between personal communications device 104 and the third party vendor. This may be done by activating: (1) the opening up of a web-browser to a webpage that has assembled the invokable icons 118 that represent the third party vendors, wherein when the patron selects the invokable icon 118, the lattert directs the browser to the web page designated by the third party vendor; (2) directly a third party vendor website accessible on personal communications device 104; (3) an application already stored on personal communications device 104 relating to one of the third party vendors; or (4) by causing the third party vendor to download the appropriate application to personal communications device 104, and then running the application.

The computer instructions and the transmission element may cause the patron's personal communications device 104 to open an internet-based landing page displaying at least one invokable icon 118 associated with at least one third party vendor. The computer instructions and the transmission element may cause the patron's personal communications device 104 to open and display an internet landing page comprising a generic home page of a website of one third party vendor. These actions of the computer instructions and the transmission element contribute to eliminating manual steps in presenting options to the patron. As will be further detailed hereinafter, the landing page may be other than a home page.

As will be further illustrated by example hereinafter, the access element may comprise near field communications functionality, functionality to receive and respond to a texted request for a link, functionality to capture and respond to a two dimensional bar code image, touch screen functionality to effect display of at least one invokable icon 118 on the patron's personal communications device 104, functionality to initiate a premises product transaction using an internet application, or any feasible combination of these. These communications functionalities enable expeditious communications to be performed using methods known to most patrons, and requiring only that the patron have his or her personal communications device 104 with him or her.

An invokable icon 118 is an image element which may be employed as an interactive interface to activate an automated function on the personal communications device 104. That is, invokable icon 118 may be touched, clicked on where using a movable cursor, or otherwise engaged by a person using premises display apparatus 102 displaying invokable icon 118 to initiate or activate the automated function. An invokable icon 118 may be interactively activated by the patron by touch, by wireless command by the cellular phone, or in any other suitable way. When invoked, the invokable icon activates the cellular phone 104 to display information such as an offer to sell or rent goods or services, related information such as scheduling of future events, or other information in which the patron may be interested.

The access element and the transmission element may comprise a low powered wireless communications protocol. These are familiar, and enable convenient communications.

Unless otherwise indicated, the terms “first”, “second”, etc., are used herein merely as labels, and are not intended to impose ordinal, positional, or hierarchical requirements on the items to which these terms refer. Moreover, reference to, e.g., a “second” item does not either require or preclude the existence of, e.g., a “first” or lower-numbered item, and/or, e.g., a “third” or higher-numbered item.

It will be understood that the computer instructions are loaded into memory 114 in a non-transitory computer-readable medium that when executed, are configured to instruct microprocessor 102 to operate premises display apparatus 102 to perform as described.

Power may be provided by an onboard battery 116 (as illustrated), by wireless power transfer, by plug and cord connection to a 120V AC power receptacle, or by a plug and cord connection to a 210V, 220V, 230V, 240V or any other AC or DC power receptacle that is used in the region (the latter options are not shown).

First input element 108 may comprise a communication element, wherein the element 108 initiates operation of the computer instructions to transmit the at least one menu choice to the personal communications device 104 when the patron touches the screen touch control or interacts in some other way such as NFC. If desired, first input element 108, depicted as a pushbutton herein, could instead comprise a voice detector, could comprise a virtual button on display screen 106, could respond to input signals from personal communications device 104, or could take still other forms.

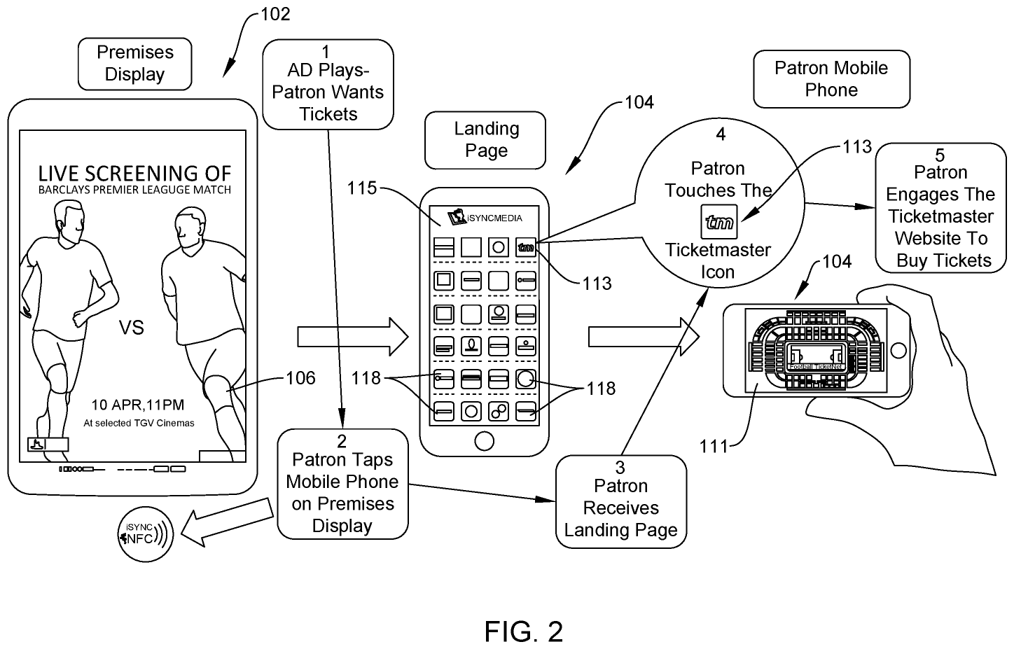

In premises display apparatus 102, the computer instructions of the premises display may cause a plurality of invokable icons 118 of third parties to be displayed on a patron's personal communications device 104. Icons 118 on the landing page are arranged and formatted to represent the user interface of patron's personal communications device 104. An example of icons 118 on a landing page is illustrated as a generic web page 115 in FIG. 2.

The computer instructions of premises display apparatus 102 may cause an advertisement of a third party to be displayed on an initial screen of premises display apparatus 102. The computer instructions of premises display apparatus 102 may cause a plurality of advertisements of third parties to be cycled for time periods ranging from 15 to 60 seconds, or any other desired time, on the premises display apparatus 102.

In premises display apparatus 102, the computer instructions and the transmission element may cause the patron's personal communications device 104 to open and display a generic home page of a website of one third party vendor when a patron selects the at least one invokable icon 118. It is important to note that the computer instructions and the transmission element cause the patron's personal communications device 114 to directly open an internet-based home page of a website of the at least one third party vendor.

In premises display apparatus 102, the computer instructions and the transmission element may cause the patron's personal communications device 104 to open and display a specific page of the website of the third party vendor when the patron selects the at least one invokable icon 118, wherein the specific page is not the generic home page. The computer instructions and the transmission element cause the patron's personal communications device 104 to directly open and display the specific page of the website of the third party vendor, wherein the specific page is not the generic home page.

The specific page is subsequent to a home page of the website or a specifically designated page independent of the website.

In premises display apparatus 102, the computer instructions and the transmission element may cause the patron's personal communications device 104 to open an application preloaded onto personal communications device 104 when the patron selects the at least one invokable icon 118. If the application has not been downloaded to the patron's personal communications device 104, the computer instructions and the transmission element cause the patron's personal communications device 104 to enable downloading of the application thereto when the patron selects the at least one invokable icon 118. In premises display apparatus 102, the computer instructions and the transmission element may cause the patron's personal communications device 104 to directly open an application preloaded into personal communications device 104.

More details on this are provided in examples below.

The premises served by premises display apparatus 102 may be a bar or restaurant (neither shown) for example, wherein premises display apparatus 102 is placed on a table or the bar. Of course, other types of businesses and institutions could utilize premises display apparatus 102, including pubs, public houses, educational institutions, hospitals, professional offices, diverse retail stores, government offices, and still others may adapt the novel principles to their purposes.

Wireless transmitter 110 may be configured to utilize a low powered wireless communications protocol, wireless transmitter 110 utilizing a BlueTooth protocol, a Wifi protocol, and/or Near Field Communication (NFC) for example. This conserves power of battery 116 and minimizes potential interferences with other communications devices.

Referring also to FIG. 2, premises display apparatus 102 displays an image representative of an activity unaffiliated with the premises having premises table top display 102. In the example of FIG. 2, premises display apparatus 102 shows an advertisement for an upcoming sports event by a ticket vendor. Upon the patron initiating communication with the premises display (to be described hereinafter), patron's personal communications device 104 responsively displays (preferably in the form of a web-based page opened in the patron's web browser upon communication with the premises display) at least one menu choice. Preferably, the at least one menu choice comprises a generic plurality of menu choices in the form of icons 118 displayed on the generic web-based page 115. In FIG. 2, twenty-four menu choices are each represented by icons 118, where each of the icons represent links to access additional information of the third party vendors that may or may not have an advertisement cycling on the premises display apparatus 102. When any one icon 118 (as will be explained hereinafter) on the patron's personal communications device 104 is invoked, the display of the patron's mobile device 104 is connected to a screen (e.g. a website) under the control of the entity (e.g. the third party vendor) associated with the invoked icon.

In the example of FIG. 2, the generic web-based page 115 includes the icon 113 of the third party ticket vendor whose advertisement indicating that tickets are available for the upcoming game is seen displayed on the premises display apparatus 102. Once the patron activates the icon specific to the vendor 113, the patron's mobile phone display 104 shows a seating scheme 111 applicable to the specific sports event initially displayed on premises display apparatus 102. The patron, if so desired, can complete the ticket purchase in a manner under the control of the third party ticket vendor. Thus, by providing the patron with a direct link to access available tickets to the specific advertised game from the generic web-based page 115, the patron is able to purchase tickets to the game in a simple and expedited manner without having to navigate through the ticket vendor's website. In addition, the third party vendor may provide its own interactive application which may then be operated on personal communications device 104. It is contemplated that in many cases, the application will process a request by the patron for sale of goods or services by the third party vendor.

In summary, where the premises comprise a restaurant or bar, menu choices such as those displayed herein will be the products of a commercial entity or third party vendor, and will not be related to the restaurant or bar. Alternatively stated, the premises are of a commercial enterprise providing goods or services related to a first subject of interest, and the at least one menu choice is related to subject matter other than that of the first subject of interest. This relationship allows the premises, such as a bar or restaurant, to promote services or products of an unrelated entity, thereby promoting commerce while not engaging in counterproductive or parasitic competition.

Examples of content which may be readily accessed by the novel protocol will be set forth. The method may comprise further steps of first, causing the premises display on the table to display an advertisement, and second, causing the cellular telephone of the patron to open to a webpage of the third party vendor with which the advertisement is associated, wherein the opened webpage enables interactive engagement with an activity offered by the third party vendor. In this example, if the premises display depicts a product which appeals to the patron of the restaurant or bar, the patron is quickly brought to a screen enabling purchasing of rights to attend, view, or otherwise interactively engaging the activity.

The computer instructions and the transmission element may cause the patron's personal communications device 104 to directly open an application preloaded into personal communications device 104. If the application has not been downloaded to the patron's communication device 104, the computer instructions and the transmission element cause the patron's personal communications device to enable downloading of the application thereto. This expedites completion of responding to advertisements, while eliminating intermediate steps involving manual entry of commands.

The data corresponding to the third party content on premises display apparatus 102 may cause premises display apparatus 102 for displaying third party vendor advertising content within view of the patron to present a dynamic progression of advertising content associated with different third party vendors, such that each third party vendor advertising content is displayed for a specified amount of time. Cycling through commercial messages, which primarily encompasses advertisements, but which may also include topics of interest such as prevailing time, weather conditions, news, etc., attracts and holds the patron's attention. Constraining content for a predetermined or specified time enables the third party vendor to control content based on when the patron interacted to cause the display of third party vendor advertising content.

Invokable icons 118 may correspond to different third party vendors or to redundantly represented third party vendors, possibly in combination with third party vendors represented only once. Also, where advertisements cycle on premises display apparatus 102, screens for any one third party vendor may have different content.

In premises display apparatus 102, the data corresponding to the third party content may cause, responsively to the patron performing the one interactive reaction with premises display apparatus 102 during the display of the third party advertising content, premises display apparatus 102 to open on personal communications device 104 a landing page displaying a plurality of invokable icons 118 related to third party vendors, wherein each invokable icon 118 is functional to establish communication between personal communications device 104 and one third party vendor associated with an invoked icon 118. The landing page may be web or application based. This procedure assists in expediting arrival of the patron at desired content.

In premises display apparatus 102, the data corresponding to the third party content may cause, responsively to the patron performing the one interactive action with premises display apparatus 102 during the time that a third party vendor advertising content is being displayed, premises display apparatus 102 to open on personal communications device 104 a webpage or application related to the third party vendor advertising content. Thus, the system may rely on the time when the patron interacted to open appropriate desired content on personal communications device 104.

In premises display apparatus 102, the data corresponding to the third party content may causes, responsively to the patron performing the one interactive action with premises display apparatus 102 during the time that a first third party vendor advertising content is being displayed, premises display apparatus 102 to open on personal communications device 104 a webpage or application related to the first third party vendor advertising content, and responsively to the patron performing the one interactive action with premises display apparatus 102 during the display of a second third party advertising content, premises display apparatus 102 to open on personal communications device 104 a landing page displaying a plurality of invokable icons 118 related to third party vendors. Each invokable icon 118 is functional to establish communication between personal communications device 104 and one third party vendor associated with an invoked icon 118. Again, the landing page is web or application based.

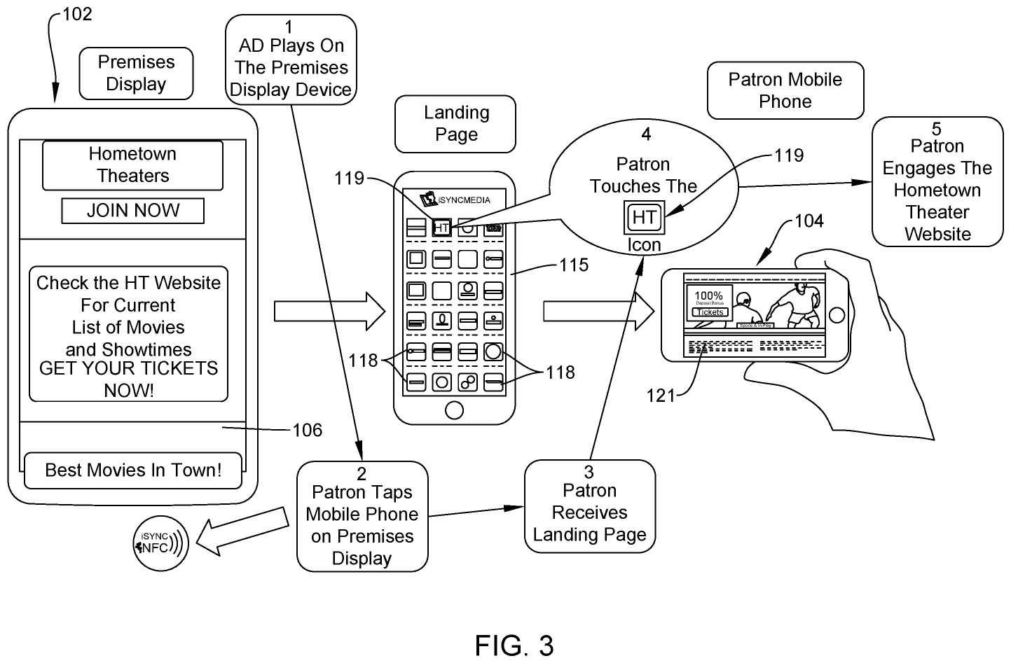

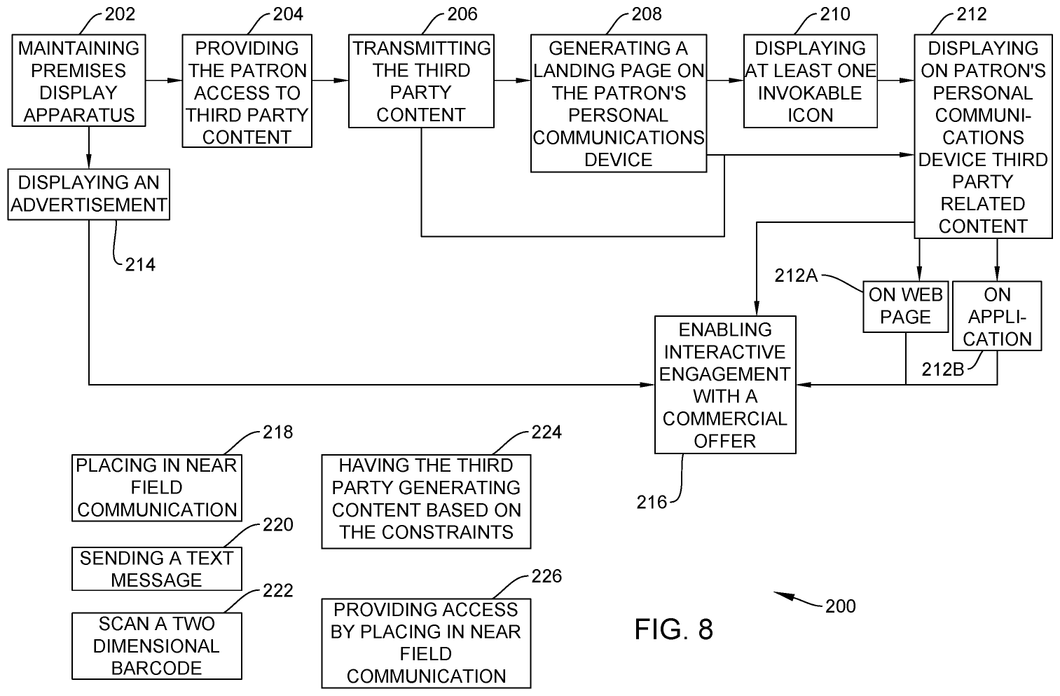

Now considering the invention as a method of implementing the communication between premises display apparatus 102 and a personal display (e.g., display screen 105 of personal communications device 104 of a patron, illustratively using the system of FIGS. 1 and 3, reference is also made to FIG. 8, in which individual steps of the method are summarized. It should be noted that FIG. 8 does not purport to show every step described herein. FIG. 8 shows major steps of the method and provides a graphical representation indicative of rapidity of advancing to a final destination of established communication between the patron's personal display apparatus 104 and third parties providing content.

By way of summary, method 200 implements a communication between a premises display (e.g., premises display apparatus 102) at a public premises to a personal display apparatus 104 by a patron of the premises. Method 200 of displaying content of at least one third party vendor on premises display apparatus 102 and communicating the third party vendor content to the patron's personal communications device 104 operated at the premises may comprise a step 202 of maintaining premises display apparatus 102 for displaying third party vendor content within view of the patron, wherein premises display apparatus 102 has a display (e.g., shown as display screen 106). Method 200 may also comprise a step 204 of providing the patron access to the third party content from premises display apparatus 102 to patron's personal communications device 104 by one interactive action by the patron, and a step 206 of transmitting the third party content to the patron's personal communications device responsively to the one interactive action.

An interactive action by the patron is any physical action such as placing personal communications device 104 in Near Field Communication with premises display apparatus 102, contacting premises display apparatus 102 where the latter operates by capacitance, texting to premises display apparatus 102, and scanning or otherwise capturing a two-dimensional bar code.

Near field communication opens a browser on personal communications device 104.

Texting may transmit a phone number or code to premises display apparatus 102. Alternatively, texting may elicit a link to a generic landing page or other page having icons 118. The patron can then click on a desired destination.

Display screen 106 may display a two-dimensional bar code. The patron may capture an image of the two-dimensional bar code with personal communications device 104 to open the browser or to send the link.

Interactively responsive to the patron's action, premises display apparatus 102 may open a browser on personal communications device 104 to any of several screens. These screens may include a generic, web-based landing page displaying plural icons 118 arranged to represent a user interface of personal communications device 104. In this example, when the patron selects an icon 118, the latter will either open a generic home page of the third party associated with the invoked icon 118, or alternatively, will open a specific page within the same third party's website or a page external to the third party vendor's website. These examples have been described above with reference to FIGS. 2 and 3. It will be understood then that icons 118 are typically used for applications, but in this instance they are instead clickable web links to third party vendors' websites, jumping directly to an opening web page of an advertising third party vendor or another web page designated by the third party vendor(s).

This feature may be utilized by third party vendors to track traffic. For example, when a specific page outside the third party vendor's website is accessed, traffic may be correlated to which premises receive that particular webpage. Content may then be tailored to circumstances. For example, patrons of the premises may be granted particular discounts not made available to all potential customers.

Also, a landing page may be tagged, as associated with one particular third party vendor.

This procedure rapidly brings the patron to his or her true point of interest on the third party vendor's website, thereby bypassing undesired website pages.

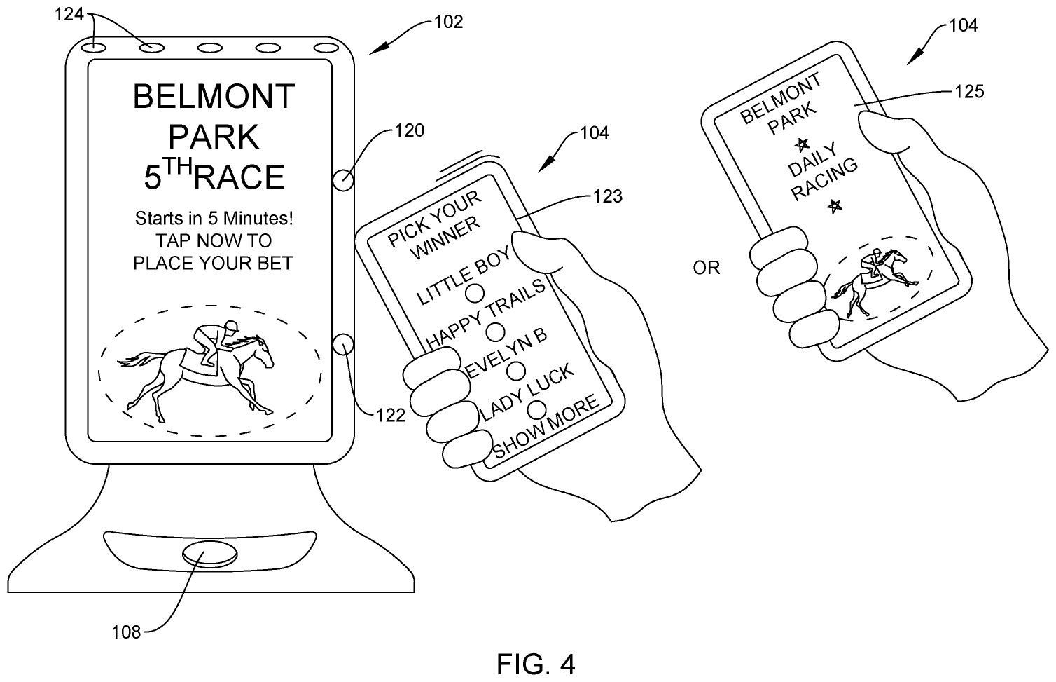

An example is shown in FIG. 4, wherein engaging premises display apparatus 102 brings personal communications device 104 to a specific web page 123, the latter capable of accepting a bet placed by the patron, using the displayed web page 123. Again, the patron rapidly negotiates a website, bypassing undesired screens.

It should be noted that although landing pages typically display plural icons 118, the present invention contemplates that it is possible that a web-based landing page will display only one icon 118. It should also be noted that a landing page may be other than web-based, e.g., associated with an application residing on personal communications device 104.

In an advantageous variation of the above, premises display apparatus 102 may bypass the landing page and perform any of the following options. One option is to open a browser on personal communications device 104 directly to the third party's website, to either a generic page or to a specific page. A second option is to open an application on personal communications device 104. A third option is, if an application is to be opened but does not already reside in personal communications device 104, the browser is presented with an opportunity to download or otherwise access the application.

Step 206 of transmitting the third party content may further comprise a step 208 of generating on personal communications device 104 a landing page displaying a plurality of invokable icons 118 each related to a different third party, wherein each invokable icon 118 is functional to establish communication between personal communications device 104 and one third party associated with an invoked icon 118. This step promotes expeditious arrival of the patron to a desired destination.

It will be appreciated that although the intent is to enable diverse third parties to be able to display content on personal communications device 104, it is not necessarily the case that each icon 118 be literally associated with a different third party. One particular third party may choose to advertise using different icons 118 included in the landing page, for example.

In method 200, step 206 of generating the landing page on personal communications device 104 may be the result of a web-browser opening to the landing page following the interactive action by the patron with premises display device 102. This enables method to utilize the internet communications with the third party vendors. Alternatively, the step 206 of generating a landing page on personal communications device may be the result of an application (referred to as “landing page application”) opening to the landing page following the interactive action by the patron with premises display device 102. If the landing page application is not on the patron's personal communications device, the interaction by the patron with the premises display will provide the opportunity to download the landing page application.

In method 200, icons 118 on the landing page may be arranged and formatted to represent the user interface of the patron's personal communications device 104. That is, the landing page may simulate the user interface by including a display of icons 118 as displayed on personal communications device 104. This presents a familiar and intuitively grasped display useful in promoting further selections by the patron.

In method 200, the landing page may contain a plurality of invokable icons 118 functional to establish communication between personal communications device 104 and websites of third parties associated with invokable icons 118. Establishing communication between personal communications device 104 and websites of third parties may comprise connecting to a webpage of the third party associated with an invoked icon 118. This eliminates unnecessary steps in a chain of events, such as tediously entering a URL into a browser.

In method 200, step 208 of displaying the plurality of invokable icons 118 functional to establish communication may comprise a step 210 of displaying at least one invokable icon 118 functional to open an application related to the third party. This step expedites communications utilizing downloadable applications in method 200.

In step 212 of method 200, and seen in FIG. 8 as step 212A, the application may reside on personal communications device 104 of the patron. This gives the patron immediate access to an application, but using the expeditious steps of engaging premises display apparatus 102 using e.g., near field communications. The option of opening the application is shown below step 212 as a step 212B.

Method 200, in the absence of an application residing on personal communications device 104, may comprise making the application available for download to personal communications device 104. This expedites any communications requiring the application, where the application has not previously been downloaded to personal communications device 104.

In method 200, step 202 of maintaining the premises display apparatus 102 for displaying third party vendor content may further comprise a step 214 of displaying an advertisement advertising a commercial activity of the third party, and a step 216 of enabling interactive engagement with a commercial offer to provide at least one of a good and a service to the patron. Thus, method 200 facilitates commerce.

In method 200, the interactive action by the patron may comprise a step 218 of the patron placing personal communications device 104 in near field communication with premises display apparatus 102. This is a very convenient and quickly performed form of interaction.

In method 200, the interactive action by the patron may comprise a step 220 of the patron sending a text message from the patron's personal communications device 104 to a number displayed on premises display apparatus 102 and then receiving a return text on patron's display device 104. This exchange of text messages may result in a web link or other information being sent to the patron and being readily captured on the patron's personal communications device 104 for future use.

In method 200, the interactive action by the patron may comprise a step 222 of the patron utilizing the patron's personal communications device 104 to scan a two-dimensional barcode displayed on premises display apparatus 102. A two dimensional barcode does not require entry steps by the patron, such as those required to text.

In method 200, step 206 of transmitting the third party content may further comprise opening on the patron's personal communications device 104 a display relating to the third party vendor. This promotes expeditious navigation by the patron towards a destination related to the third party vendor. In FIG. 8, note an optional direct path from step 206 to step 212.

In step 206 of method 200, the display may be a website related to the third party vendor. This enables a third party vendor to offer the patron the same offerings as those made available to members of the general public seeking out the website of the third party vendor.

In step 206 of method 200, the display may be an application related to the third party vendor. Applications are familiar and therefore intuitive and readily used as a communications protocol usable by customers such as the patron.

In method 200, the interactive action by the patron may be the patron placing personal communications device 104 in near field communication with premises display apparatus 102. This is a highly convenient maneuver, which enables the patron to continuously grasp personal communications device 104 in one hand.

In method 200, the interactive action by the patron may be the patron sending a text message from the patron's personal communication device 104 to a number displayed on premises display apparatus 102 and then receiving a return text on the patron's display device 104. This utilizes a commonly practiced and familiar procedure, which does not require close proximity of the patron to premises display apparatus 102.

In method 200, the interactive action by the patron may be the patron utilizing the patron's personal communication device 104 to scan a two-dimensional barcode displayed on the premises display apparatus 104. Use of a two-dimensional barcode enhances security of data transfer by employing encoding.

In method 200, the step of maintaining premises display apparatus 102 for displaying third party vendor advertising content within view of the patron may comprise a step of presenting a dynamic progression of advertising content associated with different third party vendors, such that each third party vendor advertising content is displayed for a specified amount of time. A dynamic display permits advertising by plural third parties. Use of specified or predetermined time windows enables control by the third party over content transmitted to the patron's personal communications device 104.

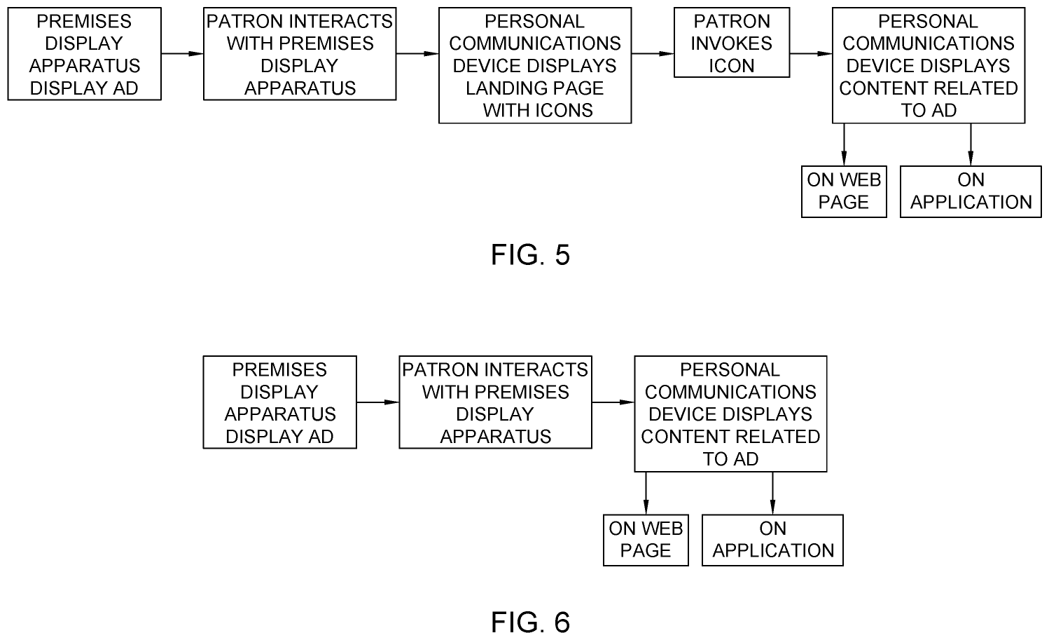

The nature and advantages of this are seen with reference to FIGS. 5-7. In FIG. 5, premises display apparatus 102 displays at least one advertisement. If interested by the advertisement, the patron interacts with premises display apparatus 102 to initiate content transmission to his or her personal communications device 104. In one of several possible scenarios, personal communications device 104 displays a web-based landing page with invokable icons 118. In the scenario of FIG. 5, the patron invokes or selects one icon 118. Responsively, personal communications device 104 displays predetermined content related to that advertisement corresponding to the invoked icon 118. This content may be that of a web page, or alternatively may be that of an application residing on personal communications device 104.

FIG. 6 shows a streamlined version of the scenario of FIG. 5. In FIG. 6, patron interaction directly causes personal communications device 104 to display predetermined content, again either that of a web page or that of an application.

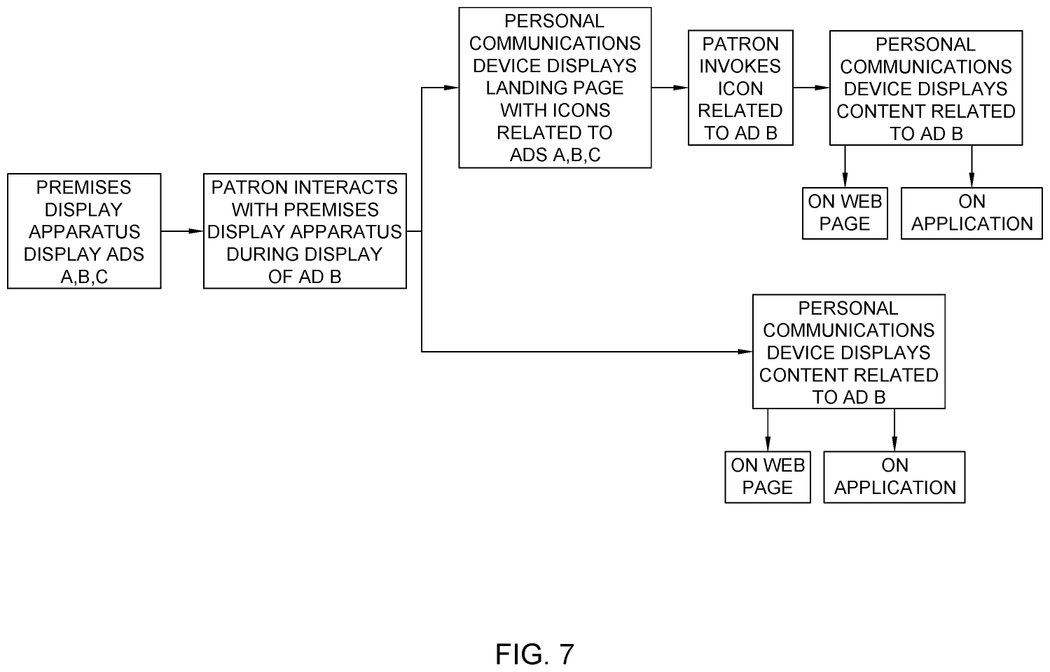

FIG. 7 illustrates regulation of predetermined content by the third party vendor, or alternatively stated, regulation according to preferences of the third party vendor when the patron interacts with the display device during the display of an advertisement of a particular third party vendor. In FIG. 7, premises display apparatus 102 cycles through a plurality of advertisements of various third party vendors (by way of example only, represented by ads A, B and C). The patron interacts with premises display apparatus 102 as described hereinbefore during the display of a given third party's advertisement. In the example shown in FIG. 7, patron interacted with the display during the time advertisement “B” is displayed. Content is then selected according to a criterion selected by the third party vendor.

For example, if the patron interaction with the display device during the display of advertisement “B” is within a first time interval, then personal communications device 104 is made to display the landing page with the plurality of invokable icons 118 corresponding to the plural third party vendors. The patron may then select or invoke that icon related to a particular advertisement “B”. This will cause personal communications device 104 to display content related to advertisement “B”, from a web page, or from an application.

However, if the patron interaction with the display device during the display of advertisement “B” is within a second time interval that relates to a specific event, deadline, or other time sensitive constraint or influence be present, then the landing page may be bypassed, and the content related to advertisement “B” will be directly displayed on personal communications device 104. The latter option applies to events which have rapidly impending time deadlines. An example is seen with respect to the scenario associated with FIG. 4 and further described herein. In that scenario, the initial advertisement offers betting services applicable to horse racing. If a particular race is about to begin, and time is of the essence in placing a bet, then the system takes advantage of its expeditious nature to route the patron directly to a screen on personal communications device 104 which will enable immediate implementation of a bet made by the patron.

In a specific implementation of method 200, step 206 of transmitting the third party content may further comprise, responsively to the patron performing the one interactive action with premises display apparatus 102 during the display of the third party advertising content, premises display apparatus 102 opening on personal communications device 104 a landing page displaying the plurality of invokable icons 118 related to third party vendors. Each invokable icon 118 is functional to establish communication between personal communications device 104 and one third party vendor associated with an invoked icon 118. Once again, the landing page is web or application based. This enables expeditious presentation of third party content to the patron, with minimal complexity in operational steps.

In method 200, step 206 of transmitting the third party content may further comprise responsively to the patron performing the one interactive action with premises display apparatus 102 during the time that a third party vendor advertising content is being displayed, opening on personal communications device 104 the webpage or application related to the third party vendor advertising content. This introduces the previously described element of control by or preferred by the third party, the control determining by the time of patron interaction which path to presentation of content will be implemented.

In method 200, step 206 of transmitting the third party content may further comprise responsively to the patron performing the one interactive action with premises display apparatus 102 during the time that a first third party vendor advertising content is being displayed, opening on personal communications device 104 a webpage or application related to the first third party vendor advertising content, and responsively to the patron performing the one interactive action with premises display apparatus 102 during the display of a second third party advertising content, premises display apparatus 102 opens on personal communications device 104 a landing page displaying a plurality of invokable icons related to third party vendors. Each invokable icon is functional to establish communication between personal communications device 104 and one third party vendor associated with an invoked icon 118. Thus, each one of plural third party vendors can have their respective advertising or other content transmitted for display on the patron's personal communications device 104, at the patron's discretion.

In a further variation of method 200, there is contemplated a method of displaying content of at least one third party vendor on premises display apparatus 102 and communicating the third party vendor content to the patron's personal communications device 104 operated at the premises. The method 200 may comprise step 202 of maintaining premises display apparatus 102 for displaying third party vendor content within view of the patron, wherein premises display apparatus 102 has a first display; step 204 of providing the patron access to the third party content from premises display 102 to the patron's personal communications device 104 by one interactive action by the patron; a step 224 of having the third party selectively generating the third party content based on time constraints influencing subsequent patron interactions with the third party content; and step 206 of transmitting the third party content to the patron's personal communication device responsively to the one interactive action. Thus, the element of time determines actual displayed content even in a simple form of method 200.

Method 200 of displaying content of at least one third party vendor on premises display apparatus 102 and communicating the third party vendor content to the patron's personal communications device 104 operated at the premises may comprise the step 202 of maintaining premises display apparatus 102 for displaying third party vendor content within view of the patron, wherein premises display apparatus 102 includes a display; a step 226 of providing the patron access to the third party content from premises display apparatus 102 to the patron's personal communications device 104 by placing personal communications device 104 in near field communications with premises display apparatus 102; and, responsively to the patron placing personal communications device 104 in near field communications with premises display apparatus 102, a step of opening personal communications device 104 to a website of the third party associated with the display of premises display apparatus 102 at the time the patron placed personal communications device 102 in near field communications therewith. Using near field communications renders the highly expeditious communication very convenient as near field communications requires only proximity rather than precise manipulation of keyboard keys, pressing specific locations on a screen, or other more demanding maneuvers.

FIG. 4 shows how a patron can engage in betting on horse racing with minimal wasted time utilizing a variation of the current method and system. As described in the scenario in the Summary of the Invention, responsive to premises display apparatus 102 displaying an advertisement for horseracing, cellular phone 104 is prompted to display a specific web page from the website of the racing venue (e.g., a race track). This is in contrast to the above embodiments where a generic page is first initiated providing a list of available icons 118. In this embodiment, when cellular phone 104 communicates with the premises display (e.g. tapped against premises display apparatus 102 utilizing NFC), while the race track advertisement is being displayed on the premises display apparatus 102, a specific web page 123 is opened on the patron's mobile phone 104 enabling the patron to rapidly enter its desired bet using its phone. The web page may display actual betting choices, as seen in the center of FIG. 4. The time from the patron first noticing the advertisement on premises display apparatus 102 to timely placing of a bet can be remarkably short, given that premises display apparatus 102 eliminates all but a minimum of gestures or manual inputs to display the appropriate website page and accept the bet. Alternatively, the page that is opened on the patron's mobile phone 104 after communicating with the premises device may display the login page or home page 125 of vendor's website. In the case when the home page 125 is opened, illustrated at the right of FIG. 4, the patron can proceed in the normal course of interacting with the website to the screen actually accepting the bet. This scenario enables implementation of the third scenario from the Summary of the Invention, wherein the patron at the local sports bar watches the horse race, and sees an advertisement to place a bet displayed on premises display apparatus 102.

It will be appreciated that prior experience with contacting a third party vendor, or even engaging premises display apparatus 102, information identifying the patron, e.g., IP address or a telephone number, may be stored in memory 114 (or in a server associated with premises display apparatus 102, or elsewhere), so that the patron is instantly recognized by premises display apparatus 102, to further expedite the patron's experience.

Now considering the specific application of the invention to a restaurant or bar, the premises offer at least one of beverages and food to the patron, and amenities of the premises include a table surface and seating at the table surface. The step of displaying to the patron the at least one menu choice may comprise the further step 230 of locating the premises display on the table and providing the premises display as a low powered wireless communications protocol. The premises display apparatus 102 is therefore in convenient proximity to the patron, and is capable of interacting with cellular phone 104 of the patron.

The above method steps may be used to implement the example set forth in the Summary of the Invention wherein the patron of the restaurant saw the advertisement for the movie by having the patron click on the appropriate icon for the theater to purchase tickets. The same holds true of course for the patron who purchased tickets to the football game. However, the distinction being, in the theater example, the invoked icon brought the consumer to the vendor's generic home-page and in the football example, the invoked icon brought the patron to the specific page to purchase tickets to the advertised game.

Thus, the step of progressing from a home page, which is not the actual object of interest, to a subsequent page which is the object of interest or specifically generated page can be performed, again without incurring tedious manual steps which are ordinarily required to get to the desired endpoint.

It is contemplated that a primary purpose of content of the premises display is to provide compensated advertising as a commercial service to the third party vendors.

Needless to say, because a principal purpose of the premises display is to expand advertising at the premises by third party vendors,

In a particular way of initiating interactive communication, the method may comprise a further step of displaying to the patron at least one menu choice on the premises display and enabling the patron to invoke a selected menu choice by contacting premises display apparatus 102 with cellular phone 104 (as illustrated in FIG. 5). Alternatively stated, the patron need only touch premises display apparatus 102 with cellular phone 104 to receive the desired web page or other menu choice, again dispensing with any number of potentially annoying intermediate steps. Touching premises display apparatus 102 may connect cellular phone 104 to a generic opening screen, or alternatively, to a specific web page of a particular third party vendor.

In a further option, the step of displaying a commercial solicitation comprises a step of cycling through a plurality of advertisements. This enables the premises to conduct advertising for a plurality of third party vendors, and also has the effect of refreshing or varying the display.

It may be observed from the preceding option that the initial display of either the premises display, or the initial screen activated on the screen of cellular phone 1-4 of the patron need not be restricted to a static display of invokable icons 118, although the latter is certainly one option.

An initial screen icon of cellular phone 104 may or may not correlate to advertisements appearing on premises display apparatus 102. For example, an advertiser may wish to have a screen presence, but may not be displaying advertising content for specific products at the time the patron engaged premises display apparatus 102. This is an example of when it is advantageous to send a link to cellular phone 104, which link opens a web page of the third party vendor.

In a further option, an initial screen icon 118, when invoked, may provide a web link to a specific page of a third party vendor website or a specifically designated page of the third party vendor.

As an alternative to displaying commercial advertisements or solicitations, it would be possible to depict or annunciate other content, such as news, schedules of upcoming events, weather information, and the like. These may be displayed from the premises display as a service or attraction, if desired by the premises owner.

It should be noted that references to sales are representative of commercial activity generally, and not literally to be construed as being limited to sales. For example, goods and services may be procured under lease and rental arrangements, either alone or alternatively, in combination with sales.

Referring back to FIG. 1, more details are provided for the premises display apparatus 102. Premises display apparatus 102 may comprise a second input element 120 functional to initiate an assistance call signal from premises display apparatus 102. In the illustrated example of FIG. 1, second input element 120 may be for example a pushbutton or capacitive control, and in a restaurant or bar, may be utilized to summon assistance from waitstaff or a bartender. Assistance may be summoned by illuminating lamps 124 for example. This feature enables premises display apparatus 102 to perform a second function (other than conducting the wireless transaction).

In a specific example, wherein the premises comprise at least one of a restaurant and a bar, the assistance call signal is visible to waitstaff. The signal may comprise a flashing light, for example. Thus, premises display apparatus 102 may further comprise a functionality to initiate an assistance call signal to the waitstaff from premises display apparatus 102.

Premises display apparatus 102 may comprise a third input element 122 providing a functionality to initiate a premises product transaction using an internet application. In the example of a restaurant or bar, the premises product transaction may be to place an order for food or beverage, or alternatively, to order and pay for the check. This helps automate an otherwise potentially manual function of a restaurant, bar, or the like.

Premises display apparatus 102 may also facilitate interactivity with wait staff and/or other systems at the venue, from mechanisms as simple as a “call button” to summon a server, to touch screen menus to place drink, food or dessert orders, to a “remote checkout” system that would allow the patron to settle his bill electronically and securely eliminating the need to wait for the server to provide this service. The call button function, for instance, could be as simple as activating an “attention needed” light (similar to those used on airliners) located at the top of premises display apparatus 102, or as complex as a wireless signal to a server at the venue that relays a message to contact the server via a notification such as display on a device such as a pager, phone, PDA, or electronic order-entry device. To enable the remote checkout function, the premises display apparatus 102 may optionally contain an electronic Card and/or RFID reader to collect payment information (e.g.: from a credit or debit card) and settle the bill at the table. The software running on premises display apparatus 102 so equipped could allow easy splitting of checks in large parties, something that is so troublesome, error-prone, and time consuming with conventional methods that many restaurants and bars decline to do it. In the case where the premises display apparatus 102 allows a high degree of live interactivity, individual patrons in the party may be able to order drinks, appetizers, or even their meal using the device, and they could later easily select the items that were theirs from the table check, add a tip, and settle the bill instantly using electronic payment such as a credit or debit card (or alternatively by leaving the indicated amount of cash behind). Electronic credit or debit transactions would be securely encrypted by the premises display apparatus 102 and communicated back to a venue support server or to some other interface to the venue's point-of-sale computer system or a third-party point-of-sale transaction system via a wired or wireless network link.

Touch screen displays come in a variety of types, including resistive touch screens, surface acoustic wave touch screens, and capacitive touch screens. A panel in a capacitive touch screen may include a sensor that is coated with a material that conducts a continuous electric current across a sensor. The electric current across the sensor results in an electric field having both a horizontal and a vertical axis, thereby achieving capacitance. A human body may also store electrons, and therefore exhibits capacitance. When a human being touches the touch screen, the sensor's electric field is thus altered by the capacitance of the human being providing the touch. The distortion in the senor's electric field can be measured, and this information can be sent to an electronic device for further processing to determine the location of the touch. Based on determination of the location of the touch, the electronic system in which the touch screen is implemented may take further action, such as selecting an item, navigating to a new location, or other appropriate action.

Premises display apparatus 102 could also be provided with more than one display screen 106. Notably, display screen 106 may be a first display screen, and premises display apparatus 102 may also comprise a second display screen 106 facing in a direction different from that of first display screen 106. Premises display apparatus 102 could incorporate the plural screen and other features of a two-sided touch screen display. More particularly, premises display apparatus 102 may include a first touch screen facing in a first direction and a second touch screen facing in a second direction that is substantially opposite of the first direction. The various layers of content may be accessed by users operating the first and second touch screens. Furthermore, a user operating the first touch screen may access content independently of content accessed by a used operating the second touch screen, and vice versa.

Premises display apparatus 102 may be deployed in a wide variety of environments in order to deliver various types of content in a restaurant. In one particular implementation, premises display apparatus 102 may be used to deliver advertising and promotional content. A number of premises displays 102 may be deployed in the restaurant, with one or more premises displays 102 at each table. Patrons at a table having a premises display apparatus 102 may access, through touch screens, items displayed on various menus (e.g., appetizers, entrees, side dishes, drinks), may view promotional items (e.g., a promotion for a certain brand of beer), and so forth. Furthermore, the content accessible from tabletop display apparatus may be further customizable depending on the particular type of venue and the demographic of a typical patron. For example, a restaurant that typically attracts a significant number of sports fans, the content may include sports scores, statistics, fantasy sports information, and other sports news. Since premises display apparatus 102 may include touch screens that face in substantially opposite directions, a user on one side can access content independently of a user on the other side. Thus, while one user is for example accessing sports scores using one touch screen, another user may independently access an appetizers menu through the other touch screen, to give one of many possible examples.

In general, a wide variety of content may be displayed by premises display apparatus 102 in various formats. The content may be varied based on a number of factors, including location (i.e. the particular venue, as well as the larger geographic location), time of day, demographic information (e.g., local demographics or demographics of typical venue patrons), season, and so on. The content may be accessed from another premises display apparatus 102 in the same venue, from a local server, or from a remote server.

In other embodiments, a premises display apparatus 102 with capabilities equivalent or similar to that of tabletop display apparatus may be used which does not necessarily have to be on, in, or even designed as a tabletop unit—for instance, it may be implemented as a wall or door-mounted unit (the former might be useful for restroom advertising in any kind of venue, the latter to keep restaurant wait staff informed of specials and dish availability as they move in and out of the kitchen), at bar counters, host/hostess stands, waiting areas, or at other appropriate locations at a suitable venue. If used as a discrete tabletop unit, then premises display apparatus 102 may be integrated with or contained by a receptacle for tabletop condiments such as salt, pepper, sweeteners, sauces, etc. Premises display apparatus 102 and/or the receptacle may also be mounted on a motorized or non-motorized “lazy susan” type of turntable (e.g., such as a turntable, not shown) bearing allowing the device to be more easily viewed from various points around or nearby the table.

The premises display apparatus 102 may be self-contained (including power supply such as a battery), but it may alternatively rely on external resources for power and/or data. Typically, A premises display apparatus 102 will be either self-contained and battery-powered, or tethered by an external power and/or data connection, for example, 802.3af Power-over-Ethernet, which provides in a single unified connection both battery charging and power connection as well as a data connection. Other arrangements are possible as well, for instance, a self-contained battery-powered unit (with an optional battery charging and power connection) that embodies a data connection as a wireless data connection for content replication and/or interaction communications with the patrons at the restaurant/bar venue. For suitably low-power touch screens, power for the premises display apparatus 102 may also be locally generated (e.g.: by solar cells or fuel cell generators powered by methanol, propane, hydrogen, or other appropriate fuels) and optionally stored in local energy storage systems (e.g.: batteries or large capacitors, which may be removable and replaceable for convenience). If the displays are self-contained, the content they contain may be updated over a data connection either by continuous or intermittent connections to a communications station (which may be integrated with a battery charging unit) or alternatively, by a wireless data link. In either case, the content may be replicated and distributed using proprietary methods or well-known standard techniques such as distributed file synchronization (e.g.: rdist, Unison, SyncToy, scripted FTP or file copy, etc.), version and/or revision control systems (e.g.: RCS, CVS, Subversion, etc.), or by a store and forward delivery system (e.g.: e-mail or uucp). Depending on the behavior desired, this content synchronization may be triggered and managed by an “upstream” computer or controller or by the premises display apparatus 102 itself—that is, the data transfer may be “push”, “pull”, or a combination of both. Note that the direction of information flow does not necessarily have to be “downstream” toward the premises display apparatus 102. One example of this might have the device collecting an auditable log of patron presence, interactive usage, display statistics, and other information that could be transferred “upstream”, while also allowing new content and control metadata instructions to flow “downstream” either simultaneously or interleaved with the upstream transmission, depending on whether full or half-duplex communications are available.

Premises display apparatus 102 may incorporate data storage, which may or may not be logically and/or physically divided to contain the executable software code and/or other programs for the premises display apparatus 102 itself (which may also include executable programs for updating said software and/or firmware). The data storage may also provide storage for the actual advertising or promotional content and control metadata data about how and when that content data should be delivered through the device's display and optionally housekeeping information such as a unique Unit ID and “health and status” information that may be used and analyzed for a variety of purposes. In a typical configuration, the data storage for advertising and promotional content may include the various content elements themselves along with control metadata. This control metadata (which may vary from a simple “play list” of sequenced content identifiers to complex programmable presentations dependent on a variety of internal or external variables) defines when and how the premises display apparatus 102 should present the content elements. For example, the control metadata might include a schedule determining which advertisements and promotions are set to run during a pre-defined time window, but may also encompass more complex behavior such as “if new patrons have not already been sensed in the past fifteen minutes (to avoid false triggering by up- and down re-seating or returns from the restroom, etc.) then display a specific advertisement for twenty-five seconds after detecting newly seated patrons, switch to content related to specials, and change the default update interval to 15 seconds”. The control metadata may be a text or binary representation, but will typically be a tag-structured text format such as Extensible Markup Language (XML) or a directly interpretable data format such as JavaScript Object Notation (JSON).

The content elements may be comprised of or include (but are not limited to):
1. images in either bitmap (e.g.: JPG, PNG, GIF, etc.) or vector (e.g.: SVG, Flash, NAPLPS, etc.) form,
2. web pages or other display markup (e.g.: HTML/CSS, XHTML/XSL, PDF, etc.), or
3. moving images (e g Animated GIF, Flash, MPEG, WMV, Quicktime, MNG, etc.) and/or audio (e.g.: MP3, AAC, WAV, etc.). Moving images may optionally include audio, which is primarily useful in settings other than those that are the primary target for the invention, since audio is generally undesirable in those settings.

In addition, premises display apparatus 102 may contain an internal clock that can be used along with the control metadata residing in the data storage to trigger a set of actions at a particular time. A typical example of this might be a set of control metadata to switch from content appropriate for Breakfast to that appropriate for Lunch at a specific single point in time, or alternatively, to phase in the content from Breakfast to Lunch over a period of time. Such control metadata may also be responsible for determining appropriate advertising or promotional content based on a variety of other criteria that may or may not be related to time, such as (but not limited to) number of views or impressions, weather or other external data, environmental information such as temperature/humidity, ambient lighting, presence and number of patrons, direct patron interaction, etc.

A further potential use of the internal clock, if made sufficiently accurate, is to synchronize and/or coordinate the changes in content across multiple premise displays 102 in a particular room or venue, to avoid the “Vegas effect” of many such displays changing in a haphazard or uncoordinated fashion. Managing screen transitions in this way may be important in maintaining the desired “atmosphere” of a restaurant or bar venue, especially if the display screen technology in use emits light. Such screen transition management may even involve coordinated schemes where the mix of “light” and “dark” screen images at a given time may be controlled and coordinated with the style and type of image transition (e.g.: fade/fade rate, direct cut, or animated transition effect) to ensure the average light intensity emitted by multiple instances of premises display apparatus 102 is maintained within a desired range across a room or venue. Such brightness coordination schemes might rely on pre-programmed schedules, or adaptive systems based on ambient light measurements, or possibly even dynamic communications with other instances of premises display apparatus 102 at the venue, either directly or through a central venue controller such as a venue support server. In such a system, the effective luminosity of each promotional or ad screen image may be pre-computed by an upstream server and distributed as part of the metadata or computed locally after the content has been replicated to the premises display apparatus 102. Either cooperative scheduling or dynamic interaction between units (either in real time, or pre-negotiated through an intermediary system such as the aforementioned venue support server) can then be used to ensure the average intensity level in a room stays roughly the same. A similar result can be achieved by pre-computing a rotation schedule for each device that allows the average brightness to remain relatively static for all devices in the room by offsetting a bright image on one device with a dark one on a neighboring device.

A two-screen premises display apparatus 102 would accommodate placement of premises display apparatus 102 in the center of a long bar or table (neither shown) while remaining within sight of patrons along the bar or table.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A premises display apparatus for displaying content of at least one third party vendor and communicating the content of the at least one third party vendor to a patron's personal communications device operated at the premises, the premises display apparatus comprising:
a display screen for displaying the third party vendor content,
a data processor including
a memory containing data corresponding to the third party vendor content, and
computer instructions configured to display the third party content on said premises display apparatus;
an access element to enable the patron's personal communications device to access the third party content;
a transmission element to enable the communication of the third party content to the patron's personal communications device.

2. The premises display apparatus of claim 1, wherein the computer instructions and the transmission element cause the patron's personal communications device to open and display an internet landing page displaying at least one invokable icon associated with at least one third party vendor.

3. The premises display apparatus of claim 2, wherein the at least one invokable icon on the landing page are arranged and formatted to represent the user interface of the patron's personal communications device.

4. The premises display apparatus of claim 2, wherein the computer instructions and the transmission element cause the patron's personal communications device to open and display a generic home page of a website of one third party vendor when a patron selects the at least one invokable icon.

5. The premises display apparatus of claim 2, wherein the computer instructions and the transmission element cause the patron's personal communications device to open and display a specific page of the website of the third party vendor when the patron selects the at least one invokable icon, wherein the specific page is not the generic home page.

6. The premises display apparatus of claim 2, wherein the computer instructions and the transmission element cause the patron's personal communications device to open an application preloaded onto the personal communications device when the patron selects the at least one invokable icon.

7. The premises display apparatus of claim 6, wherein, if the application has not been downloaded to the patron's communication device, the computer instructions and the transmission element cause the patron's personal communications device to enable downloading of the application thereto when the patron selects the at least one invokable icon.

8. The premises display apparatus of claim 1, wherein the computer instructions and the transmission element cause the patron's personal communications device to directly open an internet-based home page of a website of the at least one third party vendor.

9. The premises display apparatus of claim 1, wherein the computer instructions and the transmission element cause the patron's personal communications device to directly open and display a specific page of the website of the third party vendor, wherein the specific page is not the generic home page.

10. The premises display apparatus of claim 1, wherein the computer instructions and the transmission element cause the patron's personal communications device to directly open an application preloaded into the personal communications device.

11. The premises display apparatus of claim 1, wherein the data corresponding to the third party content on said premises display apparatus causes the premises display apparatus for displaying third party vendor advertising content within view of the patron to present a dynamic progression of advertising content associated with different third party vendors, such that each third party vendor advertising content is displayed for a specified amount of time.

12. The premises display apparatus of claim 11, wherein the data corresponding to the third party content causes, responsively to the access element of the premises display apparatus during the display of the third party advertising content, the premises display apparatus to open on the personal communications device a landing page displaying a plurality of invokable icons related to third party vendors, wherein each invokable icon is functional to establish communication between the personal communications device and one third party vendor associated with an invoked icon.

13. The premises display apparatus of claim 11, wherein the data corresponding to the third party content causes, responsively to the access element of the premises display apparatus during the display of the third party advertising content, the premises display apparatus to open on the personal communications device a webpage or application related to the third party vendor advertising content.

14. The premises display apparatus of claim 11, wherein the data corresponding to the third party content causes,
responsively to the access element of the display apparatus during the time that a first third party vendor advertising content is being displayed, the premises display apparatus to open on the personal communications device a webpage or application related to the first third party vendor advertising content; and
responsively to the access element of the premises display during the display of a second third party advertising content, the premises display device to open on the personal communications device a landing page displaying a plurality of invokable icons related to third party vendors, wherein each invokable icon is functional to establish communication between the personal communications device and one third party vendor associated with an invoked icon.

15. The premises display apparatus of claim 1, wherein the access element comprises near field communications functionality.

16. The premises display apparatus of claim 1, wherein the access element comprises functionality to receive and respond to a texted request for a link.

17. The premises display apparatus of claim 1, wherein the access element comprises functionality to capture and respond to a two dimensional bar code image.

18. The premises display apparatus of claim 1, further comprising a functionality to initiate a premises product transaction using an internet application.

19. A method of displaying content of at least one third party vendor on a premises display and communicating the third party vendor content to a patron's personal communications device operated at the premises, the method comprising steps of:
maintaining a premises display apparatus for displaying third party vendor content within view of the patron, wherein the premises display apparatus has a first display;
providing the patron access to the third party content from the premises display apparatus to a patron's personal communications device by one interactive action by the patron; and
transmitting the third party content to the patron's personal communications device responsively to the one interactive action.

20. The method of claim 19, wherein the step of transmitting the third party content further comprises
generating on the personal communications device a landing page displaying a plurality of invokable icons each related to a different third party, wherein each invokable icon is functional to establish communication between the personal communications device and one third party associated with an invoked icon.

21. The method of claim 20, wherein the step of generating the landing page on the personal communications device is the result of a web-browser opening to the landing page following the interactive action by the patron with the premises display device.

22. The method of claim 20, wherein the icons on the landing page are arranged and formatted to represent the user interface of the patron's personal communications device.

23. The method of claim 20, wherein the landing page contains a plurality of invokable icons functional to establish communication between the personal communications device and websites of third parties associated with the invokable icons, and establishing communication between the personal communications device and websites of third parties comprises connecting to a webpage of the third party associated with an invoked icon.

24. The method of claim 20, wherein the step of displaying at least one invokable icon functional to establish communication comprises displaying at least one invokable icon functional to open an application related to the third party.

25. The method of claim 19, wherein the step of maintaining a premises display apparatus for displaying third party vendor content further comprises the steps of
displaying an advertisement advertising a commercial activity of the third party; and
enabling interactive engagement with a commercial offer to provide at least one of a good and a service to the patron.

26. The method of claim 19, wherein the interactive action by the patron comprises a step of the patron placing the personal communications device in near field communication with the premises display apparatus.

27. The method of claim 19, wherein the interactive action by the patron comprises a step of the patron sending a text message from the patron's personal communications device to a number displayed on the premises display apparatus and then receiving a return text on the patron's display device.

28. The method of claim 19, wherein the interactive action by the patron comprises a step of the patron utilizing the patron's personal communications device to scan a two-dimensional barcode displayed on the premises display apparatus.

29. The method of claim 19, wherein the step of transmitting the third party content further comprises a step of opening on the patron's personal communications device a display relating to the third party vendor.

30. The method of claim 29, wherein the display is a website related to the third party vendor.

31. The method of claim 29, wherein the display is an application related to the third party vendor.

31. The method of claim 29, wherein the interactive action by the patron is the patron placing the personal communications device in near field communication with the premises display apparatus.

32. The method of claim 19, wherein the step of maintaining the premises display apparatus for displaying third party vendor advertising content within view of the patron comprises a step of presenting a cycling of advertising content associated with different third party vendors, such that each third party vendor advertising content is displayed for a specified amount of time.

33. The method of claim 32, wherein the step of transmitting the third party content further comprises:
responsively to the patron performing the one interactive action with the premises display apparatus during the display of the third party advertising content, the premises display apparatus opens on the personal communications device a landing page displaying a plurality of invokable icons related to third party vendors, wherein each invokable icon is functional to establish communication between the personal communications device and one third party vendor associated with an invoked icon.

34. The method of claim 32, wherein the step of transmitting the third party content further comprises:
responsively to the patron performing the one interactive action with the premises display apparatus during the time that a third party vendor advertising content is being displayed, opening on the personal communications device a webpage or application related to the third party vendor advertising content.

35. The method of claim 32, wherein the step of transmitting the third party content further comprises:
responsively to the patron performing the one interactive action with the premises display apparatus during the time that a first third party vendor advertising content is being displayed, opening on the personal communications device a webpage or application related to the first third party vendor advertising content; and
responsively to the patron performing the one interactive action with the premises display apparatus during the display of a second third party advertising content, the premises display apparatus opens on the personal communications device a landing page displaying a plurality of invokable icons related to third party vendors, wherein each invokable icon is functional to establish communication between the personal communications device and one third party vendor associated with an invoked icon.

36. A method of displaying content of at least one third party vendor on a premises display apparatus and communicating the third party vendor content to a patron's personal communications device operated at the premises, the method comprising steps of:
maintaining a premises display apparatus for displaying third party vendor content within view of the patron, wherein the premises display apparatus has a first display;
providing the patron access to the third party content from the premises display apparatus to a patron's personal communications device by one interactive action by the patron;
having the third party selectively generating the third party content based on time constraints influencing subsequent patron interactions with the third party content; and
transmitting the third party content to the patron's personal communications device responsively to the one interactive action.

37. A method of displaying content of at least one third party vendor on a premises display apparatus and communicating the third party vendor content to a patron's personal communications device operated at the premises, the method comprising steps of:
maintaining a premises display apparatus for displaying third party vendor content within view of the patron, wherein the premises display apparatus includes a display;
providing the patron access to the third party content from the premises display to the patron's personal communications device by placing the personal communications device in near field communications with the premises display apparatus; and
responsively to the patron placing the personal communications device in near field communications with the premises display apparatus, opening the personal communications device to a website of the third party associated with the display of the premises display apparatus at the time the patron placed the personal communications apparatus in near field communications therewith.
